(19) United States
(12) Patent Application Publication
(10) Pub. No.: US 2011/0275538 A1
(43) Pub. Date: Nov. 10, 2011

(54) MEASUREMENT OF BIOLOGICAL TARGETS

(75) Inventor: Sameer Sonkusale, Arlington, MA (US)

(73) Assignee: TUFTS UNIVERSITY, Boston, MA (US)

(21) Appl. No.: 13/060,765

(22) PCT Filed: Aug. 25, 2009
(86) PCT No.: PCT/US2009/054894

§ 371 Date: Aug. 1, 2011

Related U.S. Application Data
(60) Provisional application No. 61/091,592, filed on Aug. 25, 2008.

(51) Int. Cl. C40B 30/06; C40B 60/12

(52) U.S. Cl. 506/10; 506/39

(57) ABSTRACT

An integrated imaging system, e.g., a microsystem, for detecting activity of a biological target, for example, in response to a stimulus, includes an array of pixels arranged on a substrate, each pixel including a photodetector disposed to be in optical communication with a biological target on a surface of the substrate; and at least first and second electrodes arranged in electrical communication with the biological target.

### TECHNICAL FIELD

This disclosure relates to systems and methods for analyzing arrays of biological targets. In particular, electrical and/or optical responses or interactions of biological targets are measured, for example, when the biological targets are stimulated electrically, optically, mechanically, and/or chemically.

### BACKGROUND

There is an increasing need for systematic cell-based assays in a high-throughput screening (HTS) format for drug screening, and for biological studies. For example, an array with thousands of cells or cell lines (biological targets) can be analyzed in parallel for its response to a certain potential drug candidate for its anti-cancer properties. A cell-based assay can also be used to study phenotypic consequences of perturbing mammalian cells with drugs, genes, or interfering RNA. Such a cell-based assay can provide insights into the fundamentals of bio-signaling. For example, combined electrical signaling from single neurons in a large neuronal network with correlated information about neurotransmitter release as a function of time can be studied, in particular, in the presence of certain environmental and biochemical cues.

A biological cell or cell network, for example, a culture of neurons or electrogenic heart cells, can be described by a number of features and/or characteristic behavior patterns, such as cell or cell network geometries, chemical and biochemical kinetics, electrical and (bio)chemical signaling, physical and environmental cues, and single cell or cell network responses to artificial stimuli. To provide a detailed map of these features, one needs spatial resolution on the order of 1-10 micrometers and temporal fluctuations on the order of 1 microsecond. Understanding the cell or cell network and potentially using the cell or cell network in a controlled manner, for example, in cell engineering or therapy, calls for the capture and analysis of these features at high spatial and temporal resolutions.

### SUMMARY OF THE INVENTION

The invention is based, in part, on the recognition that standard silicon microelectronics CMOS (Complementary Metal Oxide Semiconductor) foundry techniques can be used to fabricate new imaging systems, e.g., microsystems, as described herein that can be used to simultaneously collect both optical and electrical responses of various biological targets, such as single cells or networks of cells, to various stimuli. The new systems include devices made with simple wafer level or die level CMOS compatible post-processing.

In one aspect, the invention includes integrated microsystems for detecting activity of a biological target. These systems include an array of pixels arranged on a substrate, and each pixel includes one or more photodetectors disposed on the substrate to be in optical communication with a biological target applied to a surface of the substrate; and at least first and second electrodes, e.g., a pair of electrodes, arranged on the substrate in electrical communication with the biological target. In addition, the electrodes are arranged so that they do not block light from reaching the photodetectors.

In certain embodiments, these microsystems can further third and fourth electrodes, wherein the first and third electrodes form a first electrode pair having opposite polarities and the second and fourth electrodes form a second electrode pair having opposite polarities. In certain embodiments, the surface of the substrate can include a biocompatible film for contacting the biological target and/or an intermediate film between the biocompatible film and the electrodes.

In some embodiments, the electrodes and the photodetector can be disposed within the substrate. In certain embodiments, the integrated microsystems can further include a source of a stimulus for stimulating the biological target and/or a microfluidic system for applying biological or chemical stimuli to the biological targets on the substrate.

In another aspect, the invention features methods of detecting activity of a biological target in response to one or more stimuli. These methods include disposing a biological target on a surface of one or more pixels on a substrate, wherein each pixel includes one or more photodetectors disposed on the substrate in optical communication with the biological target; and at least first and second electrodes arranged on the substrate in electrical communication with the biological target; stimulating the biological target with at least one of an optical, electrical, mechanical, and chemical stimulus; and detecting at least one of an optical and electrical response of the biological target to the stimulus.

In these methods, the biological targets can be labeled, e.g., with a fluorescent marker. In certain embodiments, these methods can further include applying an electric field to the biological targets and measuring an electric field on the biological targets using the electrodes, e.g., the third and fourth electrodes. The biological targets can also be stimulated by illuminating the biological targets with light, e.g., at a specific wavelength, such as a fluorescent wavelength. For example, the methods can include stimulating the biological target by applying a voltage.

In certain embodiments, the methods can include detecting light and/or electrical parameters, e.g., impedance, from the biological target.

In various embodiments, the biological targets are cells, e.g., a matrix of numerous cells, e.g., at least 100, 500, 1000, or 10,000 cells or more, and the cells can be disposed on the substrate in the form of a network of cells, e.g., a network of neural cells, or tissue cells. In these methods, the cells can all be the same, or can include a variety of two or more different cell types. In such embodiments, the biological targets can be stimulated by stimulating one cell in the network and detecting at least one of an optical and electrical response of a different cell in the network.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features, objects, and advantages of the invention will be apparent from the description and drawings, and from the claims.

### BRIEF FIGURE DESCRIPTION

FIG. 1 is a diagram of an imaging system.

FIG. 2 is a schematic side view of a pixel of an imaging system.

### DETAILED DESCRIPTION

The poor temporal resolution of optical spectroscopy results in a loss of some cell or cell network signaling and biochemical kinetic information. On the other hand, electrochemical techniques do not provide information with high spatial resolution. It is therefore desirable to have devices that can capture cell or cell network information with both high temporal resolution and spatial resolution. The new systems and methods described herein are based on devices that can be manufactured using standard silicon microelectronics CMOS (Complementary Metal Oxide Semiconductor) foundry techniques, and that can be used to simultaneously collect both optical and electrical responses of biological targets, e.g., single cells or networks of cells, to various stimuli.

### Imaging System Overview

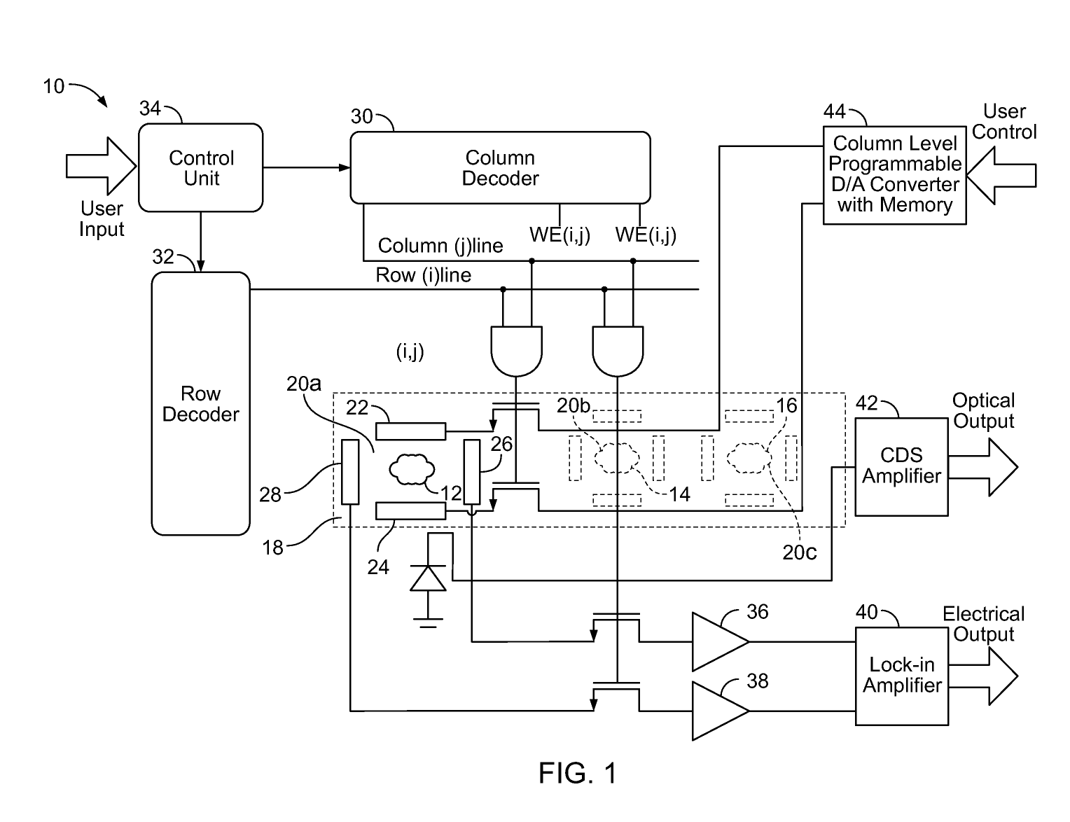

FIG. 1 shows an imaging system, e.g., microsystem, 10 for imaging biological targets 12, 14, and 16 disposed within corresponding pixels 20a, 20b, and 20c arranged in an array on a substrate 18. Examples of such biological targets include single cells, cell networks, cell matrixes, single neurons, and neural networks. A pixel 20a, as defined herein, is a unit that includes an integrated microsystem that can stimulate the biological target 12 disposed therein optically, electrically, mechanically, and/or chemically, and detect both electrical and optical responses to such stimulation.

Each such pixel 20a, 20b, and 20c can have the same or a different structure. In particular, the pixel 20a includes electrodes 22, 24, 26, 28, described in more detail below, in electrical communication with the biological target 12. In response to a control signal, a first pair of electrodes 22 and 24 applies electrical stimulation to a selected biological target 12. A second pair of electrodes 26 and 28 collects electrical responses from the biological target 12. In general, at least one pair of electrodes is required, in which case the pair of electrodes is used both to apply any required stimulation and to collect any electrical responses from the biological target. However, any number of electrodes over two per pixel can be used.

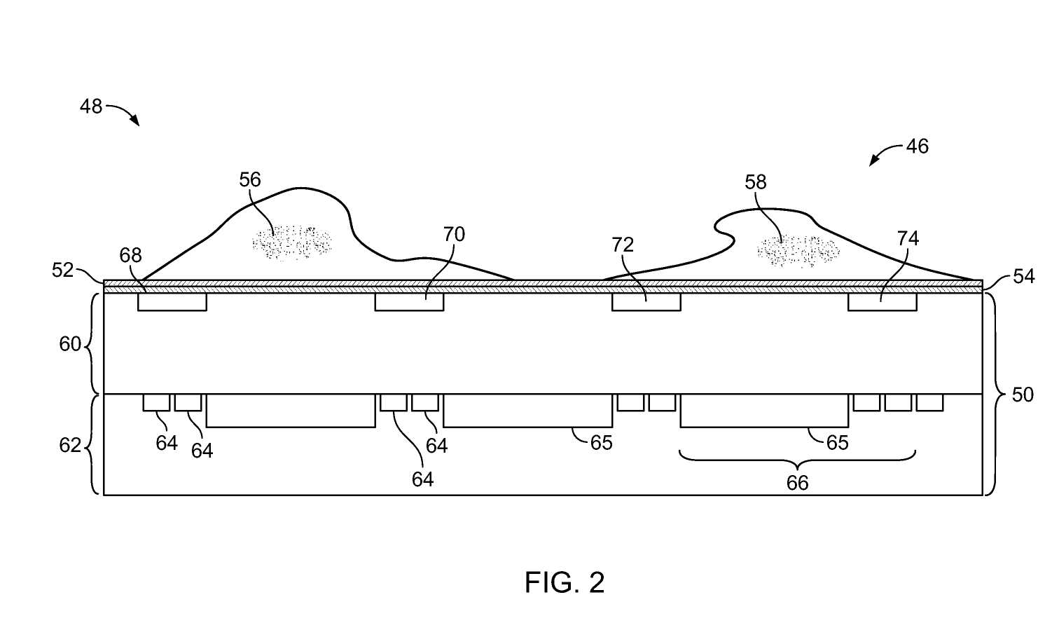

The pixel 20a also includes a corresponding photodetector 66, described in connection with FIG. 2, in optical communication with the biological target 12, and corresponding CMOS transistors (best seen in FIG. 2) below the biological target 12. The photodetector 66 captures the optical response of the biological target 12. The CMOS transistors are connected for electronic readout of optical signals. Typical electronic readout circuits can employ a 3-transistor pixel structure as in active pixel sensor (APS)-based CMOS cameras. Other readout circuit architectures can also be implemented. An important point is that the photodetector 66 is arranged such that the n-well 65 is not blocked from incident light by the electrodes.

The electrodes 22, 24 of pixel 20a are connected to a column decoder 30 and a row decoder 32, respectively. A control unit 34 connected to both the column decoder 30 and row decoder 32 receives user input regarding the electrical stimulation to be applied to the particular pixel 20a. In response, the control unit 34 drives the column decoder 30 and row decoder 32 to activate the first electrode pair 22, 24, thereby electrically stimulating the biological target 12.

Each such pixel 20a, 20b, and 20c can collect an electrical response, such as an impedance, to an electrical stimulation. For a particular pixel 20a, the second pair of electrodes 26, 28 measures an electrical response of the biological target 12 to the electrical stimulus. One example of such a response is the impedance between the electrodes 26, 28. In such impedance spectroscopy, a reference sinusoidal signal is applied as an electrical stimulus. The outputs from each electrode 26, 28 pass through corresponding preamplifiers 36, 38.

The resulting amplified output signals from the pre-amplifiers 36, 38 are then further processed using a lock-in amplifier 40 to extract their magnitude and phase information through lock-in sensing. Some embodiments save space by having the lock-in amplifier 40 be shared by all pixels in the same column. This allows more pixels to be arranged within a given area, thereby increasing the pixel density. Time division multiplexing among the sharing pixels allows the column lock-in amplifier 40 to read and amplify the individual pixel outputs. The output of the lock-in amplifier 40 is then digitized using an analog-to-digital converter. In some embodiments, a different architecture that does not require a lock-in amplifier could be used to extract the magnitude and phase information. In fact, any circuit needed to process the output from the electrodes can be implemented using the underlying CMOS substrate on which this device is built.

Each pixel 20a, 20b, and 20c can also collect an optical response to an electrical stimulation. These optical responses are captured by the n-wells 65 below each biological target 12, 14, and 16. The n-wells 65 and the related transistors 64 together form the photodetectors 66. The outputs of the photodetectors 66 are processed by a 3-T pixel architecture, or other variations of CMOS imagers, to generate an optical output. For example, if chemiluminescent tags are used to monitor the release of certain neurochemicals, then the change in the intensity of light will directly correspond to uptake or release of those neurochemicals. Reagents including electrochemically generated luminescence of novel tris(2,2′-bipyridyl)ruthenium(II) molecular labels can be used for monoamines and neuropeptides.

A column-level correlated double sampling (CDS) amplifier 42 connected to the photodetectors 66 removes any fixed pattern noise from the optical output. The fixed pattern noise can originate from the circuit due to built-in offsets and 1/f noise. The noise can also be contained in the input signal. The resulting filtered output is then digitized by the analog-to-digital converter.

Each pixel 20a, 20b, 20c can also collect an optical or an electrical response to an optical, rather than an electrical, stimulation in ways similar to those described above. The optical stimulation can be generated by an external light source, for example, a laser beam. In some embodiments, an optical stimulation is applied to a large area of the biological target 12, 14, 16, in each corresponding pixel. In other embodiments, the optical stimulation is applied locally to a single cell or a number of cells in the biological target. Similarly, each pixel 20a, 20b, 20c can collect responses to any mechanical or chemical stimuli, e.g., the application of a potential new drug candidate to the array of pixels.

The output of each pixel can include optical and/or electrical information at a sampling rate of the entire array. The electrical output contains detailed information about the spatial and temporal electrical changes resulting from various bio-molecular and physical mechanisms within the biological target, for example, within a cell and between cells in a cell network. The optical output complements the electrical output by providing information about the spatial changes.

In one example, the spatial and temporal distributions of dopamine in a neuronal network are captured by the electrical and optical information from the pixels and optical spectra are generated therefrom. In particular, the optical transmission or absorbance spectra captured by the photodetector 66 allows one to determine the presence or absence of a certain biological entity of interest at a certain location. The spectra also allow studies of cell growth and evolution. Further, the spectra facilitate detecting key biochemicals that are fluorescently tagged and tracking their diffusion. The optical and electrical outputs can be combined to provide information about time-varying cellular activity of the biological target 12 at a high temporal resolution.

In some embodiments, one can adjust the spatially varying resolution of the information obtained from each pixel by controlling the number of electrodes and photodetectors that span each pixel. In other embodiments, at least one pixel includes more than one photodetector. By having multiple photodectors per pixel, one can identify the spatial location of an optical response with greater precision. This effectively increases the optical resolution associated with that pixel. Similarly, in other embodiments, at least one pixel includes more than one pair of electrodes for collecting an electrical response from the pixel. The multiple pairs of collecting electrodes in such embodiments facilitate collecting the electrical response at a higher spatial and temporal resolution.

In other embodiments, the imaging microsystem 10 includes variations and alternative circuit implementations other than those shown in FIG. 1. In one example, an analog-to-digital conversion is implemented at each pixel to provide a higher temporal resolution. Such an implementation maintains high-speed parallel data acquisition and data processing even as the size of the array, e.g., number of pixels in the array, increases. In another example, a lock-in mixer is used for each pixel.

In still other embodiments, the imaging microsystem 10 includes an automatic feedback control with an on-board microprocessor, such as a central processing unit (CPU), which can be used to target those cells having a particular optical or electrical response to create a bidirectional interaction between biological cells and electronic components.

### The Pixels

Referring to FIG. 2, first and second pixels 46, 48 are arranged adjacent to one another in a row on a substrate 50. The substrate 50 has a bulk layer 62 and an intermediate layer 60. The intermediate layer 60 has a surface coated with a filter film 54. A biocompatible film 52 coats the filter film 54. First and second biological targets 56, 58 are randomly disposed on the biocompatible film 52 in the corresponding first and second pixels 48, 46, respectively.

The filter film 54 can be a dichroic filter. In some embodiments, the filter film 54 includes TiO₂, SiO₂, MgF₂, gold, or aluminum. These materials can be deposited using thin film deposition techniques, such as chemical vapor deposition (CVD), low-pressure CVD (LPCVD), or sputtering in a clean room. The thickness of the filter film 54 can range from 50 nanometers to about 1 micrometer. The filter film 54 acts as an optical filter to permit only selected optical responses of the biological targets 56, 58 to reach the photodetectors 66. For example, the filter film 54 can ensure that any light used for background illumination of the cells does not reach the photodetectors 65.

The biocompatible film 52 is a biocompatible material, for example, parylene, collagen, or polydimethylsiloxane (PDMS) between 10 nanometers and 1 micrometers thick. The biocompatible film 52 increases capacitive interaction between the electrodes 68, 70, 72, 74 and the biological targets 56, 58. In addition, the biocompatible film 52 also allows direct cell growth on each pixel.

The substrate 50 is a typical cross-section of a wafer from a standard microelectronics foundry. The bulk layer 62, for example, is a p-type substrate. The bulk layer 62 of the substrate 50 also includes n-wells 65, and CMOS transistors 64, for example, PMOS and/or NMOS transistors. The CMOS transistors 64 are routed through various metal interconnects within the intermediate layer 60. The metal interconnects can be in the form of layers, with the number of such layers ranging from 1 to about 10. Contacts connect metal in one of the layers with metal in another of the layers. In some embodiments, the metal layers are spaced by an interlayer dielectric, such as SiO₂.

The photodetectors 66 can be p-n junction diodes realized using the n-well layer 65 and bulk layer 62. Each photodetector in the array of photodetectors 66 is in optical communication with the biological target 56, 58 disposed in its associated pixel.

The CMOS transistors 64 laid out in the substrate provide a way to access each n-wells 65 and to communicate the output of each photodetector 66 to the CDS amplifier 42 for further signal processing. CMOS transistors 64 and metal interconnects are used to realize the implementation of all electronic elements, examples of which include the transistor pixels 20b, or preamplifiers 36 and 38 in each pixel, the row decoder 32, the column decoder 30, the control unit 34, and the lock-in amplifier 40.

A first pair of electrodes 68, 70 is in electrical contact through capacitative coupling with the first biological target 56. A second pair of electrodes 72, 74 is in electrical contact with the second biological target 58. The electrodes 68, 70, 72, 74 are also in electrical contact with the CMOS transistors 64 through the intermediate layer 60. The first and second pixels 48, 46 each include electrodes other than those shown in FIG. 2. These additional electrodes are arranged on the substrate 50 in a manner similar to those shown. The intermediate layer 60 can facilitate routing of electrical signals from the electrodes 68, 70, 72, 74 to the CMOS transistors 64.

The biological targets 56, 58 can include independent cells, for example, electrogenic heart cells, neuron cell bodies, or a single cell bacteria, and/or interconnected cell networks, for example, neuron networks. In some embodiments, different pixels contain cells or cell networks of different types. In other embodiments, cells or cell networks in different pixels are grown on the substrate 50 for differing amounts of time.

In some embodiments, the biological targets 56, 58 are tagged with fluorophores. In some cases, only selected cells in the biological targets 56, 58 are tagged. In other cases, only cells at various selected locations are tagged. In some embodiments, fluorophores tagged to the cells emit light, e.g., fluorescent light, at a wavelength different from that of the light incident on the cells.

Generally, the substrate 50 is fabricated as a chip using standard micro-fabrication techniques at a foundry. Instead of biocompatible and filtering films 54, 52, a coating that includes silicon nitride or polyimide covers the surface of the foundry-fabricated substrate 50 that the electrodes are exposed to. To make the pixels shown in FIG. 2, the substrate 50 from the foundry is further processed by etching away the silicon nitride or polyimide coating and depositing the biocompatible and filtering films 54 and 52 in their place. Finally biological targets 56, 58 are grown in each pixel on the biocompatible film 52. The CMOS transistors 64, which are isolated from the biological targets 56, 58 by the intermediate layer 60, the filter film 54, and the biocompatible film 52, are placed in close contact with the electrodes 68, 70, 72, 74.

Such an arrangement avoids parasitic noises and other issues associated with stand-alone bulky instrumentation. Moreover, complicated wiring and synchronization problems related to multiple electrodes can be avoided through multiplexing and/or demultiplexing of signals in a manner similar to that used in conventional static random access memory and dynamic random access memory architectures. Row and column decoders access each pixel in the same way that they would access memory cells in standard SRAM and DRAM, where row and column decoders along, with sense amplifiers, read bits of information from each memory cell.

### Applications of the Imaging Systems

The imaging systems such as system 10 illustrated in FIGS. 1 and 2 can be used to detect and analyze a biological target's response to any one or more of, e.g., pairs of, electrical stimulation, optical stimulation, mechanical stimulation, and chemical stimulation. For example, one can have electrical stimulation and optical readout, optical excitation and electrical readout, and optical and electrical stimulation and optical and/or electrical readout.

In some embodiments, optical stimulation arises from an external light source that applies an incident light beam to the biological targets. The incident light beam can have a wavelength in the visible region. Lasers or LEDs can also be used for incident light. In such embodiments, an optical response from the optically-stimulated biological targets is captured by the photodetectors.

The electrical stimulation can be applied by applying a voltage across selected electrodes. In such embodiments, responses from the biological targets can be captured using the same or different pairs of electrodes. The biological targets can also be stimulated by mechanical means. In addition, chemicals, e.g., drugs or potential drug candidates can be applied to the biological targets, e.g., by microfluidic channels, using standard techniques. Thus, the new imaging systems can be used for rapid screening of new drug candidates.

The biological target can be stimulated in multiple ways, e.g., mechanically, chemically, and electrically, simultaneously, by applying the multiple stimulations to the biological targets. In some implementations, only one type of stimulation is applied to the biological target, which can lead the biological target or other related biological targets to cause stimulation of other biological targets in multiple ways. For example, a drug candidate can be applied to a cell to stimulate the cell chemically. That cell may then move and/or secrete a substance and thereby stimulate neighboring cells both mechanically and chemically.

Responses from the biological targets are captured and analyzed as discussed herein. Signals are generated corresponding to each response and are directed through the integrated circuits for processing. Information concerning the cells' or cell networks' performance is then extracted.

Additional embodiments are those in which the electrical, optical, mechanical, and/or chemical stimuli are applied to a selected region of the biological target and the electrical and/or optical response of the biological target in the same region is captured and analyzed. In other embodiments, one or more stimuli are applied to selected regions of a biological target and the electrical and/or optical response of a different region of the biological target is captured and analyzed. The combined electrochemical and optical characterization of the biological target enables high resolution spatial and temporal mapping of complex biochemical processes at a cellular level.

The imaging system 10 illustrated in FIGS. 1 and 2 can also be used to study interactions of biological targets in a network in the absence of external stimulations. For example, one can use the imaging system 10 to study the interactions of cells in a network during the growth of the cells. The imaging systems such as the ones illustrated and described herein can be used as functional sensors for the rapid detection of pathogens and toxins associated with food, agriculture, and the environment.

An example of the network of biological targets can be a cell-based bioassay. The cell-based bioassay can allow for high throughput functional exploration of genomes and can provide insights into understanding the roles of the genes in cell function. Complex metabolic pathways in cell and network functions can be elucidated. The new imaging systems also provide a highly integrated, single chip solution for studies of parallel drug screening based on multiple biological targets. The biological targets can be isolated from one another or connected in a large network.

In some implementations, the bioassay can be used for high throughput drug screening to potentially evaluate drug targets. The imaging systems can provide functional characterization of effects of a drug on cells based on measurements of the responses of the cells. For example, specificity and efficacy of potential drug candidates can be assessed. Cells or parts of the cells that reacts with the drug with unknown mechanisms can be identified. The new imaging systems can provide a platform for in-vitro studies of activities of the drug within the bioassay, e.g., the absorption, distribution, metabolism, and excretion (ADME), and the toxic effects (Tox) of the drug candidate on the cells.

The cell-based bioassays can also be used as a biosensor of known and unknown harmful environmental and food-borne toxins and pathogens. The imaging systems can collect information provided by the biosensor to elucidate, for example, the mechanism of infection of the cells grown in the bioassay.

When the cell-based bioassay includes a network of neuron cells, the study of the bioassay using the new imaging systems can provide results of interest in neuroscience, neuroprosthetics, and the pharmaceutical community. For example, understanding of the responses of the neuron cells individually and collectively in the network can reveal complex cellular and molecular processes that lead to Alzheimer's, Parkinson's and other neurological disorders. The new imaging systems can serve as a tool to facilitate searching for cures to debilitate these or other medical conditions.

### Other Embodiments

A number of embodiments of the invention have been described. Nevertheless, it will be understood that various modifications may be made without departing from the spirit and scope of the invention (e.g., more than four electrodes can be included in each pixel). Accordingly, other embodiments are within the scope of the following claims.

1. An integrated microsystem for detecting an activity of a biological target, the system comprising:
an array of pixels arranged on a substrate, each pixel comprising
a photodetector disposed on the substrate to be in optical communication with a biological target applied to a surface of the substrate; and
at least first and second electrodes arranged on the substrate in electrical communication with the biological target.

2. The system of claim 1, further comprising third and fourth electrodes, wherein the first and third electrodes form a first electrode pair having opposite polarities and the second and fourth electrodes form a second electrode pair having opposite polarities.

3. The system of claim 1, wherein the surface of the substrate includes a biocompatible film for contacting the biological target.

4. The system of claim 3, wherein the surface of the substrate includes an intermediate film between the biocompatible film and the electrodes.

5. The system of claim 1, wherein the electrodes and the photodetector are disposed within the substrate.

6. The system of claim 1, wherein the integrated microsystem further comprises a source of a stimulus for stimulating the biological target.

7. A method of detecting activity of a biological target in response to a stimulus, the method comprising:
disposing a biological target on a surface of one or more pixels on a substrate, wherein each pixel comprises a photodetector disposed on the substrate to be in optical communication with the biological target; and at least first and second electrodes arranged on the substrate in electrical communication with the biological target;
stimulating the biological target with at least one of an optical stimulus, an electrical stimulus, a mechanical stimulus, and a chemical stimulus; and
detecting at least one of an optical response and an electrical response of the biological target to the stimulus.

8. The method of claim 7, further comprising labeling the biological target with a fluorescent marker.

9. The method of claim 7, further comprising applying an electric field to the biological targets and measuring an electric response of the biological targets using third and fourth electrodes.

10. The method of claim 7, wherein stimulating the biological target comprises illuminating the biological target.

11. The method of claim 7, wherein detecting at least one of an optical response and an electrical response further comprises detecting light from the target.

12. The method of claim 7, wherein detecting at least one of an optical response and an electrical response comprises measuring an impedance.

13. The method of claim 7, wherein disposing a biological target comprises disposing cells in the form of a network of multiple cells.

14. The method of claim 13, wherein stimulating the biological target comprises stimulating one cell in the network and detecting at least one of an optical response and an electrical response of a different cell in the network.

15. The method of claim 7, further comprising selecting the biological target to be a cell matrix.
